(19) United States
(12) Patent Application Publication
(10) Pub. No.: US 2002/0180798 A1
(43) Pub. Date: Dec. 5, 2002

(54) System and method for extending a wireless device platform to multiple applications

(76) Inventors: Graham V. Poor, Raleigh, NC (US); Margaret Mary Mahoney, Raleigh, NC (US)

Correspondence Address: NEEDLE & ROSENBER, P.C., The Candler Building, Suite 1200, 127 Peachtree Street, N.E., Altanta, GA, 30303-1811, US

(21) Appl. No.: 09/873,123

(22) Filed: May 31, 2001

(51) Int. Cl. G06F 3/00

(52) U.S. Cl. 345/781

(57) ABSTRACT

Multiple application programs in wireless devices are managed and controlled by a software bus and a control file or similar readily programmer-configurable data-driven mechanism. Buttons or other discrete user interface input controls are linked to commands in the application programs in a platform-independent manner using the control file. In a touch-screen-based device, for example, the control file or other such mechanism defines the sequences in which a user can navigate screens and the user interface controls displayed to a user on each screen. A user interface control activation or similar user input event causes an address to be written to the bus, which responds by invoking a corresponding method, such as one that causes a new screen to be displayed. New application programs can be added to the device and readily integrated with existing programs by updating the control file.

### CROSS-REFERENCE TO RELATED APPLICATION

Co-pending application Ser. No. ______, filed ______, entitled “SYSTEM AND METHOD FOR REMOTE APPLICATION MANAGEMENT OF A WIRELESS DEVICE” is related.

### BACKGROUND OF THE INVENTION

1. Field of the Invention

The present invention relates generally to the execution of application programs on hand-held digital wireless data communication and computing devices of the types generally referred to as hand-held computers, personal digital assistants, cellular telephones, pagers and the like.

2. Description of the Related Art

A distinct category of electronic communication and computing devices increasingly referred to in the art simply as “wireless devices” is coalescing from the previously distinct fields of mobile computing and cellular telephony. The category includes devices commonly referred to as palmtop or hand-held computers, personal digital assistants, organizers, “smart” cellular telephones, pagers, and the like. Cellular and similar mobile telephones and telephone-like devices include computer application program-like functions, such as games, contact managers and e-mail. Personal digital assistants (PDAs) and other computer-like devices can include remote communication functions such as wireless networking for communicating e-mail and data. The convergence of wireless digital communication and mobile computing has given rise to wireless devices with substantial application program-like functionality.

There are presently few standards for wireless devices in the areas of operating systems and user interfaces. The operating systems of most wireless devices are proprietary to their manufacturers and thus not used in wireless devices produced by other manufacturers. Some wireless devices have user interfaces based upon a touch-screen display with which one can interact using a stylus or finger, while others have actual user interface controls a user can depress, and still others have a miniature alphanumeric keyboard on which a user can type. Wireless devices having various combinations of touch-screens and user interface controls are known. Display size and shape varies considerably among wireless devices. Of those having user interface controls, the style, placement and number of user interface controls varies considerably. In some devices, one uses directional user interface controls or joystick-like pucks to navigate among menu options or move a cursor on the screen, while in others one uses the touch-screen to perform such functions. Also, the mechanisms that wireless devices use to store and retrieve data in memory vary considerably. The differences among platforms are expected to increase, as new technologies emerge for user interfaces, data storage, communication and other functions. For example, wireless devices and similar platforms having a voice-based user interface instead of user interface controls and touch-screens have been suggested.

Differences among wireless device platforms (the term “platform” referring to the environment defined by the device hardware in conjunction with its operating system software) have frustrated third-party software developers' efforts to create application programs that are executable on more than one platform. To be executable on a specific platform, the program must properly interface with the user interface controls or other user interface inputs and the screen or other user interface outputs. For example, the application program must take into account the size and shape of the screen to ensure that information written to the screen appears in the intended position and format. Similarly, the program must properly interface with whatever mechanism the platform uses to store and retrieve information in memory and whatever mechanism the platform uses for network communication. An application program such as an e-mail client that is written to be executable on one platform will generally not be executable on another platform. Thus, if a software developer wishes to market an e-mail client application program, a different version must be written for each platform to whose users the developer wishes to market the program.

The advent of the JAVA language, promulgated by Sun Microsystems, Inc., has brought some limited uniformity to wireless devices. As illustrated in FIG. 1, a JAVA application program 12 can be written to execute on a wireless device having a JAVA virtual machine (JVM) software layer 14. JVM layer 14 resides on top of whatever native operating system software and hardware combination 16 characterizes the platform. Including JVM layer 14 that can execute JAVA application 12 can obviate writing a native application 18 that more directly executes on native operating system software and hardware combination 16. The difficulty of this approach to achieving cross-platform application program compatibility is that JVM layer 14 may not be the same across all platforms. The limitations on memory and power in wireless devices generally prevents including a full Java Virtual Machine implementation. Consequently, JVM layer 14 in some wireless devices may represent a more complete implementation of Sun Microsystems' JVM standard than in others. An application programmer cannot be certain that an application program written to take advantage of specific JAVA features will run on all platforms having JVM layer 14 because some platforms may support that feature and others may not. In an effort to remedy this problem, an industry standards committee developed the Connected Limited Device Configuration (CLDC) and Mobile Information Device Profile (MIDP) specifications. Including CLDC and MIDP layers 20 provides a limited but standardized JAVA environment for which programmers can write applications 22 that will work on all such devices.

Another limitation of wireless devices is that their operating systems do not provide mechanisms for readily switching from one application program to another or allowing application programs to share components. Wireless device application programs are generally self-contained in the sense that they do not share components. Operating systems for personal computers, such as MICROSOFT WINDOWS, include sophisticated methods such as the dynamically linked library (DLL) for juggling application programs, sharing software components, and similar interrelated operating system tasks, but the memory and power limitations of wireless devices generally inhibit use of such methods. Thus, wireless devices typically use the simplest of methods for launching and controlling the execution of programs. For example, activating a user interface control (either an actual pushuser interface control or a graphical user interface control appearing on a display) may cause a program to begin executing. The program may present output to the user in the form of screen displays and receive input from the user in the form of user interface control activations. When the program has finished executing or at such other time as the user desires, the user can lauch and interact with another program in the same manner. Each program is, in essence, a self-contained block of software code, and only one program is executable at a time. The programs do not inter-operate with each other. The inefficiencies of such methods will become apparent with an increase in the number and variety of application programs that become available for wireless devices.

It would be desirable for an application program to run on any of a variety of wireless device platforms without necessitating a different version of the program be written for each platform. It would further be desirable for application programs to be more efficiently added to a wireless device and for them to be integrated and inter-operable with one another. The present invention addresses these problems and deficiencies and others in the manner described below.

### SUMMARY OF THE INVENTION

The present invention relates to controlling and managing application programs in digital devices, including personal digital assistants, mobile telephones, pagers and the like.

In one aspect, the invention links or associates application program user interface functions to platform-dependent embodiments of those functions in a manner that allows application program user interfaces to operate consistently across different platforms.

In another aspect, the invention links or associates user interface controls or other discrete user input controls to commands in the application programs in a platform-independent manner using a control file or similar control mechanism by which a programmer can readily define or modify these linkages or associations between inputs and commands. Although in the exemplary embodiment the inputs relate to user interface controls for purposes of illustration, in other embodiments the inputs can relate to joysticks, knobs, and voice-recognition input mechanisms. Using the control file or other control mechanism, discrete user inputs from which a user can select, such as user interface controls displayed on a screen, can be linked to commands associated with different application programs. The control file or other such mechanism defines the sequences in which a user can navigate screens and the user interface controls displayed to a user on each screen. New application programs can be added to the device and readily integrated with existing programs just by updating a control file.

It is to be understood that both the foregoing general description and the following detailed description are exemplary and explanatory only and are not restrictive of the invention, as claimed.

### BRIEF DESCRIPTION OF THE DRAWINGS

The accompanying drawings illustrate one or more embodiments of the invention and, together with the written description, serve to explain the principles of the invention. Wherever possible, the same reference numbers are used throughout the drawings to refer to the same or like elements of an embodiment, and wherein:

FIG. 1 illustrates wireless device platform layers known in the prior art;

FIG. 2 illustrates exemplary wireless device platform layers in accordance with the present invention;

FIG. 3 is a top view of an exemplary PDA-like type of wireless device in accordance with the present invention;

FIG. 4 is a block diagram of the elements of the wireless device of FIG. 3;

FIG. 5 illustrates an example of the linkage of application program screens to one another in accordance with a control file;

FIG. 6A illustrates an example of linkage of a user interface control to an application program command;

FIG. 6B is similar to FIG. 6A and illustrates the effect of the addition of another application program;

FIG. 7A is a portion of an exemplary control file;

FIG. 7B is a continuation of FIG. 7A;

FIG. 8 illustrates the software bus that links button presses and similar user interface control activations to application program methods;

FIG. 9 is a sequence diagram illustrating the sequence of events with respect to the operation of the bus in response to a button press;

FIG. 10 is a flow diagram illustrating the process of altering the application program set installed in the device;

FIG. 11 is an object class diagram of the major classes involved in interacting with the user interface of the device;

FIG. 12 illustrates the elements involved in translating between platform-independent user interface functions and platform-dependent user interface functions;

FIG. 13 illustrates the elements involved in translating between platform-independent data storage functions and platform-dependent data storage functions;

FIG. 14 illustrates the elements involved in translating between platform-independent input/output (I/O) functions and platform-dependent I/O functions

FIG. 15 is a sequence diagram illustrating the sequence of events with respect to platform-independent user interface functions;

FIG. 16 is a sequence diagram illustrating the sequence of events with respect to platform-independent data storage functions; and

FIG. 17 is a sequence diagram illustrating the sequence of events with respect to platform-independent I/O functions.

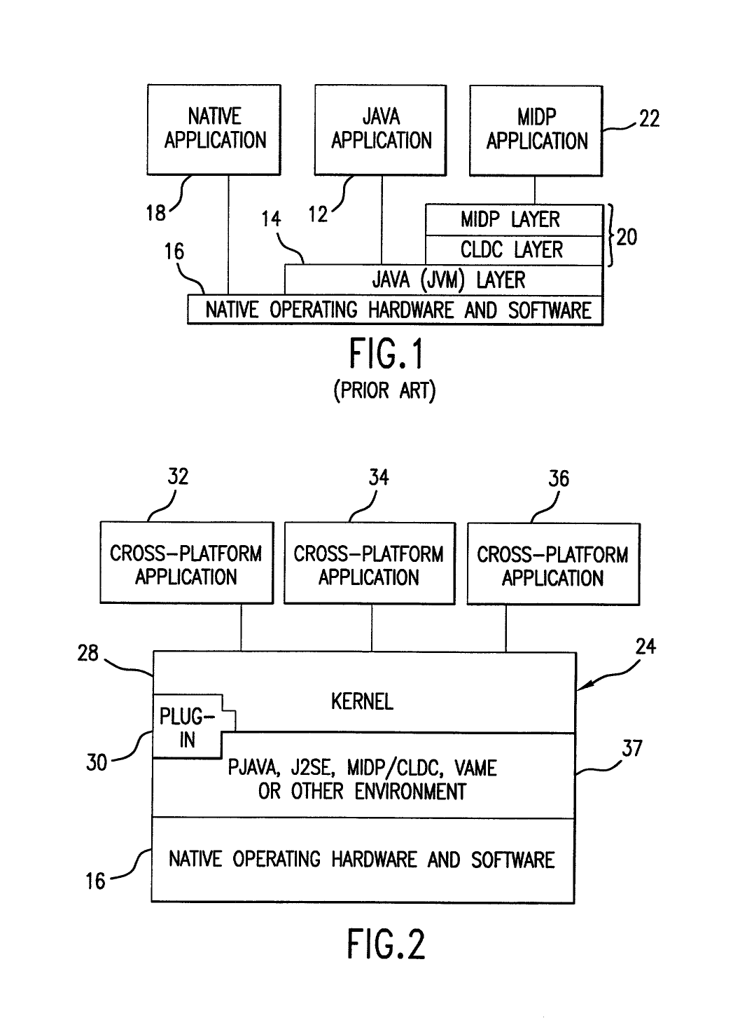

### DETAILED DESCRIPTION

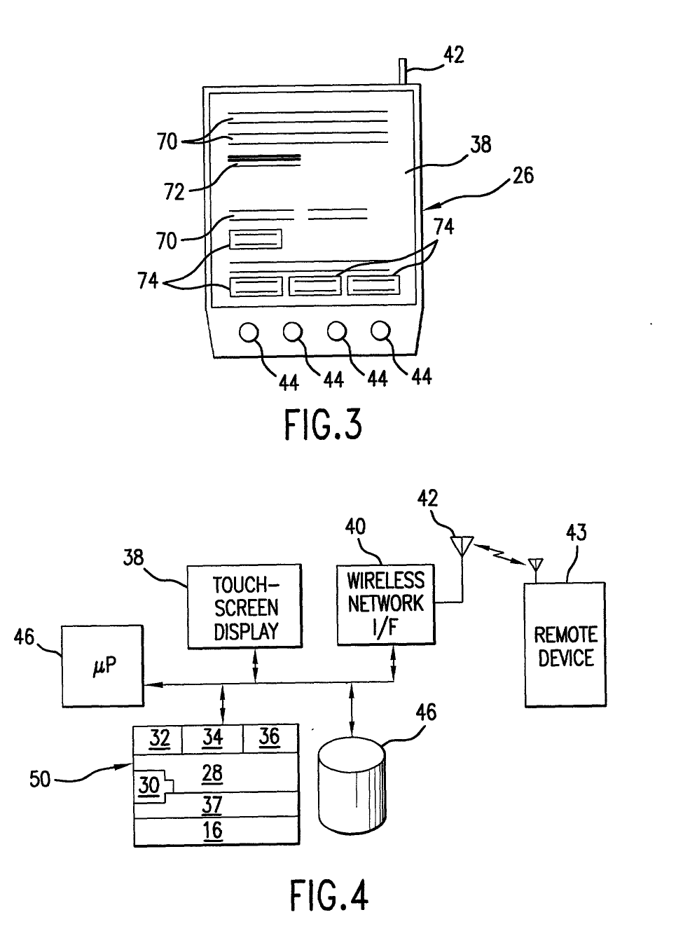

As illustrated in FIG. 2, a framework or collection of object classes 24 resides, in the illustrated embodiment of the invention, in an electronic digital device 26 (FIG. 3). Framework 24 includes kernel classes 28 and plug-in classes 30, described in further detail below. Framework 24 is a layer of software that conceptually resides between the native operating hardware and software 16 and application programs 32, 34 and 36, in effect providing an interface between them. (There is no significance to the depiction of three such application programs 32, 34 and 36 other than to illustrate that more than one, i.e., a plurality, can reside in device 26 simultaneously.)

The term “object” is used in this patent specification in the context of object-oriented programming (OOP), with which persons skilled in the art to which the invention relates are familiar. Among the relevant OOP concepts are that the work that is done when the software is executed is done by objects, and that objects encapsulate both methods and data and can communicate with each other through their interfaces. Programmers define classes by writing software code in an OOP language such as JAVA. When software is executed, objects are instantiated; an object is an instance of a class. It is contemplated that framework 24 be written in JAVA or a similar language. JAVA may provide some advantages over other languages presently known in the art, but other languages presently known and that will likely be developed are suitable.

One of the advantages of the invention is that it allows each of application programs 32, 34 and 36 (“applications”) to be written and to operate in a device-independent manner. In other words, the application programmer need not create one version tailored to the platform-defining characteristics of device 26 and another version tailored to the characteristics that define some other platform. Each of application programs 32, 34 and 36 will operate in essentially the same manner regardless of the platform onto which it is loaded.

The term “platform” refers to the total hardware and software environment in which application programs 32, 34, and 36 operate. The platform is thus defined by the combined effect of native operating hardware and software 16 and any other operating environment 37. (In the illustrated embodiment of the invention represented by device 26, operating environment 37 is a software layer existing between native operating hardware 16 and framework 24, but in other embodiments such a layer may not exist or may be different.) For example, as illustrated in FIGS. 3 and 4, a hand-held device commonly referred to as a wireless personal digital assistant (PDA) may resemble device 26 in that it includes: a touch-screen display 38, a wireless network interface 40 (note antenna 42) for communicating with a remote device 43, some pushbuttons 44 and a storage subsystem 46. All of these are elements of native operating hardware and software 16. The combined effect of these elements and any other operating software elements, such as environment 37, is what defines the platform; changing any one of these elements results in a different and distinct platform. If, for example, instead of touch-screen display 38 and buttons 44 as the primary elements of the user interface there were a voice-recognition and voice synthesis-based user interface, persons skilled in the art would consider the platform to be entirely different and distinct. Moreover, even if native operating hardware and software 16 of device 26 were identical to those of another device (not shown), but device 26 were to include a MIDP/CLDC operating environment 37 whereas the other device included a J2SE environment, persons skilled in the art would consider the platforms to be entirely different and distinct. Indeed, the term “platform” is often used more loosely in the art to refer to operating environment 37 alone. For example, one may refer to a certain brand of PDA as being a “J2SE platform.” In addition to MIDP/CLDC, there are a number of other types of operating environments 37 that are well-known alternatives for PDAs such as device 26, including Sun Microsystems' personal JAVA (pJAVA), IBM's Visual Age Micro Edition (VAME), JAVA 2 Platform Standard Edition (J2SE), and kAWT (kJAVA-environment flavor of Sun Microsystems' Abstract Window Toolkit (AWT)). Likewise, in embodiments of the invention in which the device more closely resembles a mobile telephone, environments comprising similar alternatives are known. In accordance with the present invention, an application program operates in essentially the same way from the perspective of a user, regardless of what type of user interface, storage mechanism or network protocol is provided by the native hardware and software of the device on which it is loaded, regardless of whether the native hardware and software make the device seem more PDA-like, phone-like, pager-like, or more like something else, and regardless of what type of operating environment software layer the device may have.

In FIG. 4, all of the software elements described above with regard to FIG. 2 are conceptually illustrated as residing or stored in a memory 50 so that they can be operated upon under control of microprocessor 46. Nevertheless, they are shown in this manner for purposes of illustration only; persons of skill in the art will appreciate that, in accordance with the well-known manner in which computers and similar devices of the type to which the invention pertains manage their software elements, not all such elements need reside simultaneously or in their entireties in memory 50. Likewise, there may be additional software elements in memory 50 that are not shown for purposes of clarity. Note that memory 50 represents a working memory of the type from which executable software is conventionally executed in such devices, and storage subsystem 46 is a memory of the type in which application programs typically store files and similar data. Nevertheless, in other embodiments of the invention, there may be no distinction between these two types of memory or, conversely, they may be distinct from an application program's perspective but physically embodied in the same hardware. Storage subsystem 46 is analogous to disk drive memory in a desktop computer, but in device 26 it is contemplated that it be physically embodied in solid-state memory rather than a disk to maximize reliability and economize on the overall size of device 26, which, like any conventional PDA, is intended to be small enough to hold in a user's hand.

“Plug-in” classes 30 are so termed because they can be easily added to kernel classes 28 to adapt kernel classes 28 for a specific platform. The concept of a software “plug-in” is well-understood in the art and is common in software such as web browsers, where different users may prefer to include different capabilities. The concept applies in the present invention because a manufacturer of device 26 prefers to take advantage of the capabilities of that platform, which inherently differ from those of a different platform. For example, a first set of plug-in classes 30 may be added to kernel classes 28 in embodiments of the invention in which the platform is J2SE-based, a second set may be added in embodiments in which the platform is VAME-based, a third set may be added in embodiments in which the platform is defined by a voice-based user interface instead of a more typical touch-screen based user interface, and so on. In other words, it is contemplated that a uniform set of kernel classes 28 will be provided in any commercial embodiments of the present invention, and that new sets of plug-in classes 30 will be developed as new platforms become commercially available. The present invention thus allows existing application programs 32, 34, 36, etc., to operate properly on a newly developed platform by installing the corresponding set of plug-in classes 30 for that platform. Each platform has its own corresponding set of plug-in classes 30 but the same set of kernel classes 28 as other platforms.

Application programs 32, 34 and 36 interface with native operating hardware and software 16 of device 26 through a suitable application program interface (API) (not shown) implemented by framework 24. In accordance with the cross-platform operability concept described above, a uniform set of API functions are included in framework 24 without regard to the platform in which framework 24 is installed. An application program that uses the API will run properly on any platform.

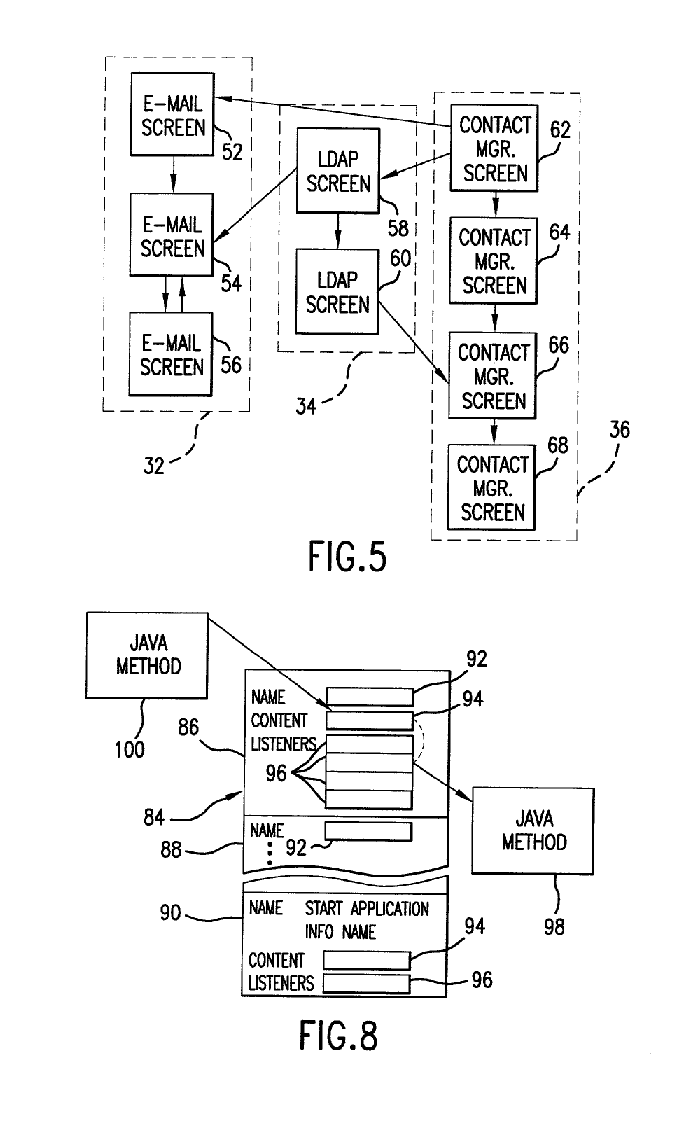

An application program (32, 34, 36, etc.) can be conceptually structured as a group of screens through which a user navigates. As illustrated in FIG. 5, application program 32 can be, for example, an e-mail client, and considered to comprise the screens 52, 54 and 56; application program 34 can be, for example, a directory program based upon the lightweight directory access protocol (LDAP), and considered to comprises the screens 58 and 60; and application program 36 can be, for example, a contact manager, and considered to comprises the screens 58 and 60. These are well-known application program functions and mentioned only as examples, and application programs 32, 34 and 36 can be of any other suitable type, such as a web browser.

An advantage of the present invention is that application programs 32, 34 and 36 can be integrated with one another to an extent greater than known in the prior art. The arrows within each of application programs 32, 34 and 36 represent the sequence or sequences in which a user can navigate from screen to screen. The number of screens and the arrangement of the arrows shown in FIG. 5 are not significant and intended for illustrative purposes only. An application program may have few screens or many screens associated with it. The term “screen” refers to what is displayed for the user on touch-screen display 38 (FIG. 3). In device 26 the user interface is a graphical user interface (GUI) along the lines of that which is common in some PDAs, mobile phones and similar digital devices. Accordingly, examples of some of the types of text, graphics, images, windows and icons that can be displayed by this GUI are shown in FIG. 3. A screen can include, for example, some text 70, some of which may represent a hyperlink 72 or other hot or active text of the type conventionally displayed by web browser application programs. A screen can similarly include, for example, buttons 74. As in conventional application programs having graphical user interfaces, buttons 74 are graphical representations of user interface control inputs and resemble actual or physical buttons in appearance. As well-known in the art, a user can activate or press button 74 by touching that area of touch-screen display 38.

As used in this patent specification, the phrase “activation of a user interface control” and similar language refers to any suitable type of user action responsive to a user input control, including pressing (actual) button 44, touching (virtual or graphical) button 74 or other graphical user interface control such as hyperlink 72, an icon, scroll bar, menu option, pull-down tab, or other active graphical feature. The term “control” or “graphical user interface control” is commonly used in the art to refer to all such active graphical features. The selection or activation can include actually touching the user interface control in touch-screen embodiments of the invention, pressing an actual button in other embodiments, speaking a voice command in still other embodiments, and any other suitable type of user input response known in the art.

The novel integration of application programs 32, 34 and 36 with each other is represented by the arrows in FIG. 5 that cross from one to another. For example, a user interacting with screen 58 associated with the directory application program 34 can cross over to screen 54 associated with the e-mail application program 32. In other words, display 38 changes from displaying screen 58 to displaying screen 54. Such a screen change can be effected in response to the user activating a button or other graphical user interface control on screen 58. In this example, the cross-over from application program 34 to application program 32 is transparent to the user, who need not be aware of exactly which of application programs 32, 34 and 36 is executing at any given time.

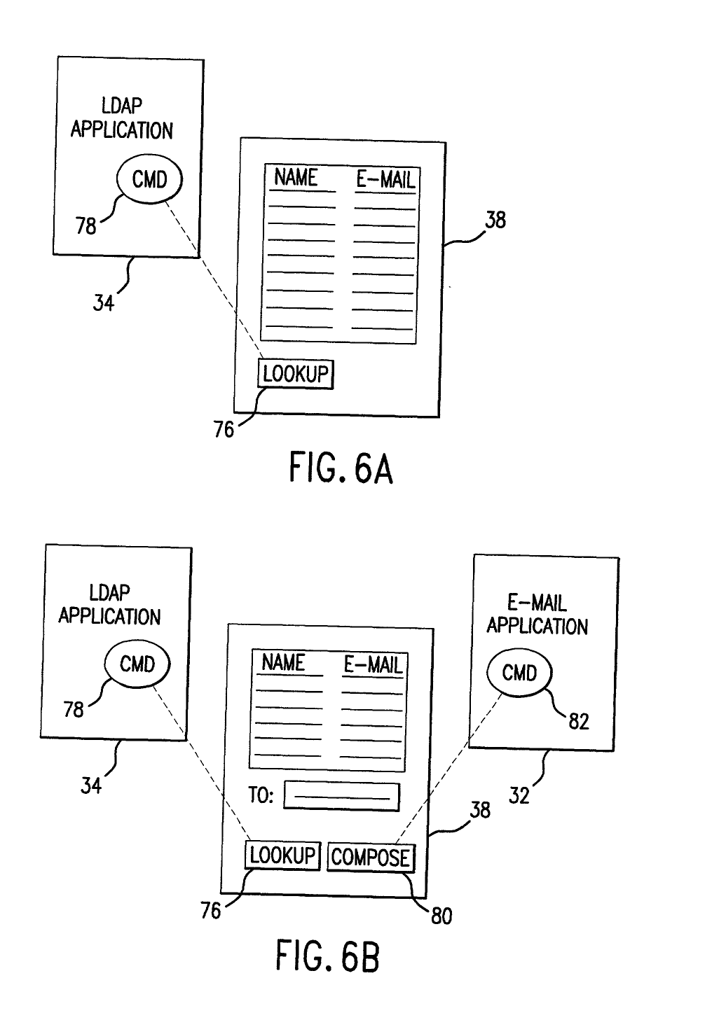

For example, as illustrated in FIG. 6B, directory application program 34 can cause a screen to be displayed with a button 76 labeled “LOOKUP,” the activation of which by a user causes a command 78 associated with directory application program 34 to be performed. Command 78 may, for example, cause another screen to be displayed with a list of names and corresponding e-mail addresses. A user can select a name (e.g., by touching it). If the user then activates a button 80 labeled “COMPOSE,” a command 82 associated with e-mail application program 32 is performed that causes another screen to be displayed in which the e-mail address corresponding to the selected name has been inserted into a box labeled “TO:______.”

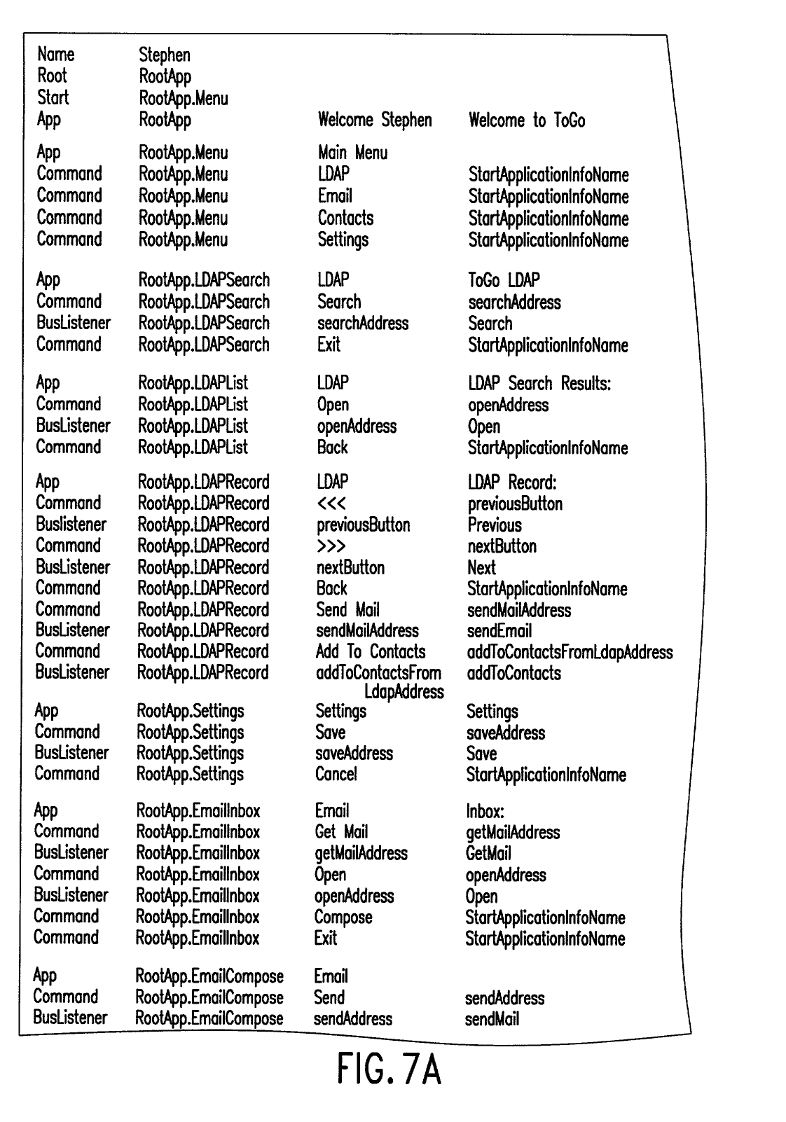

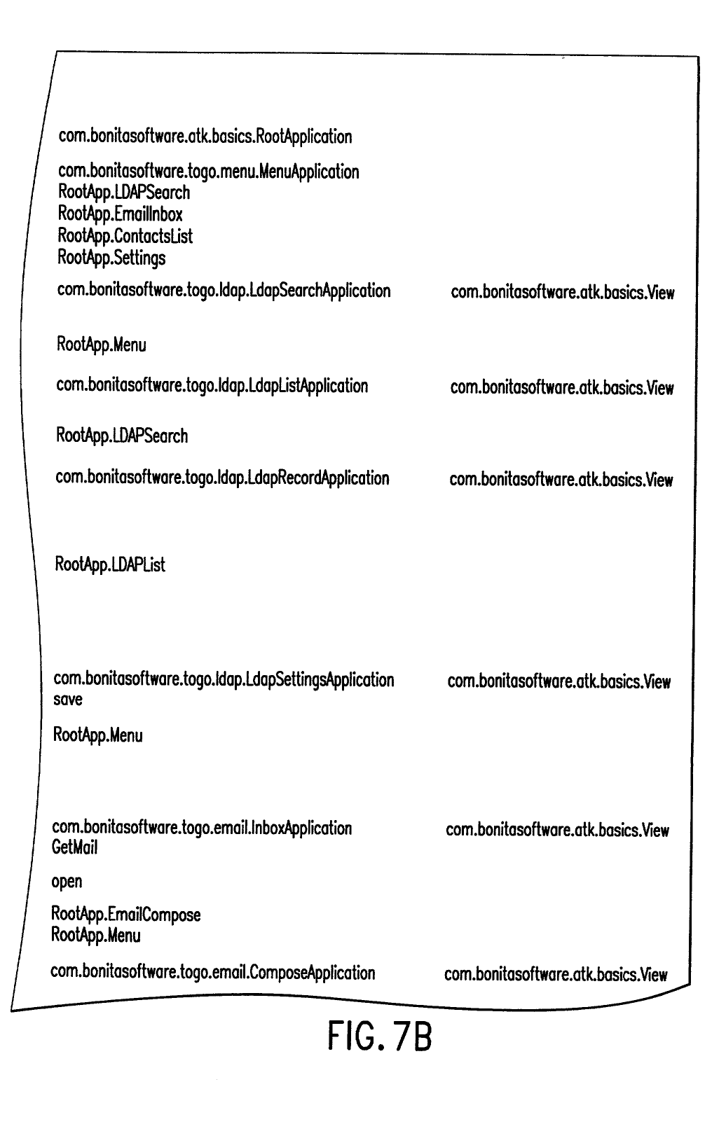

The integration between application programs 32 and 34 in the example described above is achieved through the use of a control file such as that of which a portion is illustrated in FIGS. 7A and 7B. The illustrated portion of the control file has six columns, the first three being shown in FIG. 6A and the second three being continued in FIG. 6B. The meanings of the elements in the columns are described in detail below, but note that some of the element names include references to “LDAP,” i.e., the directory function, and others include references to the “e-mail” function. In the example described above in which device 26 includes application programs 32, 34 and 36, the control file would include references not only to the e-mail and directory functions but also the contact manager function represented by application program 36. The control file can be created using any suitable authoring means, such as a text editor or a spreadsheet program, and the fields can be delimited in any suitable manner such as columns or separating elements with commas or other characters. The control file is loaded into device 26 in essentially the same manner as application programs 32, 34 and 36. As described below, the control file controls how the screens are arranged, what buttons or other user interface controls are displayed, how they are labeled, and the JAVA method associated with each user interface control.

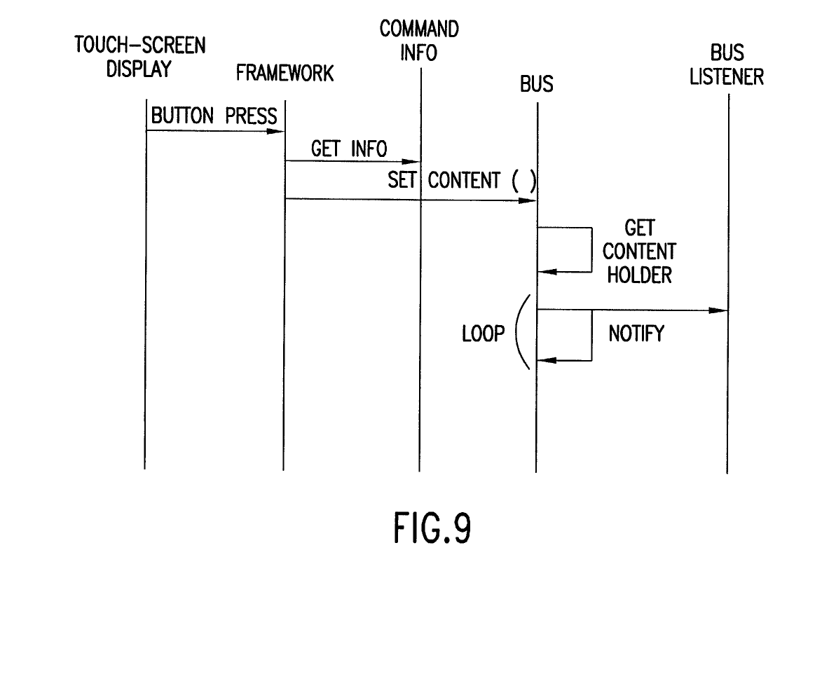

The manner in which the activation of a user interface control results in the performance of a command is illustrated in FIGS. 8 and 9. As illustrated in FIG. 8, the concept centers around an object structure referred to in this patent specification as a “bus” 84. Like a hardware bus of the type commonly referred to in the context of computer hardware as a control bus (other types of such busses being address, data and power busses), bus 84 performs the control bus-like function of, in a generalized sense, allowing one participant on the bus to transfer control to another. Unlike a computer hardware bus, bus 84 is implemented in software. While the concept of a software bus is in and of itself well-known in the art, in the context of the illustrated embodiment of the invention, bus 84 is a collection of content holders 86, 88, 90, etc., each having a name 92 that represents a bus address, a content 94, and one or more bus listeners 96. Bus 84 and its elements can be defined by a suitable JAVA class structure. Although a complete content holder 86, a portion of a second content holder 88, and a third content holder 90 are shown for purposes of illustration, there can be any suitable number. Each bus listener 96 corresponds to a JAVA method 98 associated with one of application programs 32, 34 and 36 or with framework 24 itself. Each command is performed by invoking one or more JAVA methods 98. For purposes of clarity, only one method 98 is illustrated in FIG. 8.

Other JAVA methods 100 in framework 24 respond to the activation of user interface controls by writing values to the addresses referred to as “content” 94. The activation of a specific user interface control results in the writing of a value to a content 94 of one content holders 86, 88, 90, etc. The value depends upon the command associated with the user interface control and the state of the program. For example, the value can be an e-mail address in the case of the example described above in which the user activates “COMPOSE” button 80 (FIG. 6B). One of content holders 86, 88, 90, etc. detects that the value stored in its content 94 (which is an address) has changed and, in response, notifies each of its one or more bus listeners 96. Each of bus listeners 96 has an address and a JAVA method 98 associated with it. In response to the notification, each bus listener calls or invokes the JAVA method 98 associated with it. FIG. 9 is a sequence diagram representing the above-described operation.

Content holder 90 has a different name (“StartApplicationInfoName”) from other content holders 86, 88, etc., because their bus listeners 96 are created by and associated with the application program then executing, whereas bus listener 96 of content holder 90 is created by and associated with framework 24 itself. This framework bus listener 96 responds to a change in content 94 by invoking a JAVA method 98 having a name that is the same as the value to which content 94 changed. The JAVA method 98 is associated with a different application program 32, 34 or 36 from the one that had been executing. This important mechanism is the means by which activating a button or other user interface control associated with or linked to a method associated with a first application program causes a method associated with a second application program to be invoked. The bus concept allows device 26 to in effect switch from executing one application program 32, 34 or 36 to another, transparently to the user, because it makes any JAVA method 98 of any loaded application program accessible from any other loaded application program 32, 34 or 36. The bus concept removes the boundaries of application programs by treating the set of loaded application programs 32, 34 and 36 as a single superset of their JAVA methods 98. Note that not only object methods of application programs 32, 34 and 36 but also any remote devices and servers (not shown) that can communicate with device 26 can be allowed to participate or write data to a bus address controlled as described above.

Returning briefly to FIGS. 6A and 6B, note that the composition of the screens depends upon the combination of application programs that are loaded and the control file that defines how those application programs are integrated. For example, assume the only application that is present in device 26 is directory application program 34, as illustrated in FIG. 6A. The control file defines a screen that includes only a “LOOKUP” button 76. Activating button 76 causes a list of names and addresses, such as street addresses or e-mail address, and perhaps other information, to be displayed. Selecting an item from the list can cause other information relating to that name to be displayed, such as a telephone number, but no other user interface controls are displayed because the only function of application program 34 (at least in this simple example) is to display such information. If e-mail application program 32 is then added to device 26, such that device 26 includes both directory application program 34 and e-mail application program 32, a different screen can be defined. Instead of the screen (FIG. 6A) that includes only “LOOKUP” button 76, a screen that includes both “LOOKUP” button 76 and “COMPOSE” button 80 can be displayed, as illustrated in FIG. 6B. As explained above, the buttons or other user interface controls that are included in screens and the manner in which they are associated with JAVA methods to effect commands associated with the user interface controls is defined by the control file. In the exemplary scenario described above, a new control file is loaded that defines such a screen with both button 76 and button 80 and links them to their associated commands.

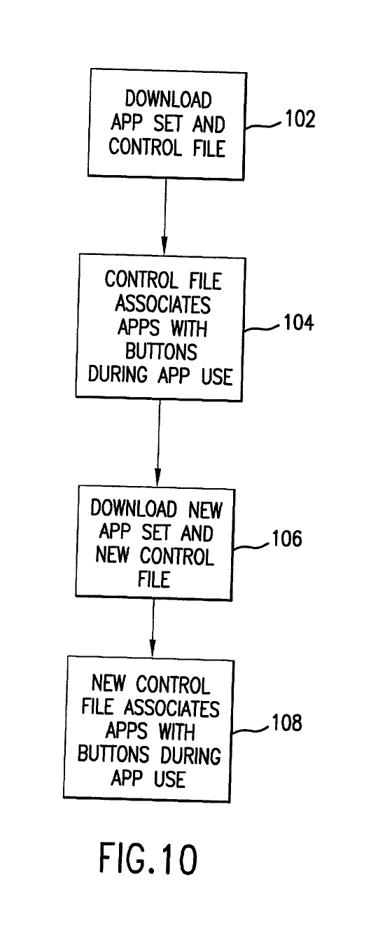

Although not necessarily so, it is contemplated that a control file be loaded into device 26 contemporaneously with the loading of a set of application programs into device 26, the removal of one or more application programs from device 26, or any other change in the combination of application programs loaded. Thus, as illustrated in the flow diagram of FIG. 10, a set of one or more application programs and a control file that integrates them are loaded into device 26 at step 102. They can be downloaded from a remote source (not shown) via the wireless network connection or loaded or installed in any other suitable manner. At step 104, when a user runs the programs, framework 24 reads the control file and uses the information to control the screen displays and effect the JAVA methods associated with user interface control activations, as described in further detail below. At step 106, a new set of application programs and a control file that integrates them are loaded. The step of loading a “new” set is intended to encompass adding one or more application programs to the then-loaded or existing set, removing one or more application programs from the existing set, substituting a new set for the existing set, and any other changing of the combination of loaded application programs. Likewise, loading a “new” control file means updating the control file in any manner, whether replacing an existing one or modifying it. The new control file can integrate the newly loaded application program with any that have been loaded previously, thereby introducing new screens with new combinations of user interface controls associated with the JAVA methods of the newly installed application. (See step 108.) In the above-described example of loading e-mail application program 32 into device 26 when it included only an existing directory application program 34, from the perspective of the user of device 26 the directory lookup function gained an e-mail capability or, alternatively, the new e-mail function retained the directory lookup function. Moreover, note that the sequence of screens, the user interface controls displayed on those screens, and the methods invoked by activating those user interface controls can be changed by simply updating a control file (e.g., replacing an existing control file with a new one). From a user's perspective, he is presented with a seemingly different GUI without the application programs themselves having changed.

With regard to FIG. 10, it is contemplated that each of application programs 32, 34, 36, etc. be loadable at any suitable time, including at the time a user requests to run it. In other words, a home screen or root screen (not shown) can display, for example, icons representing a menu of application programs 32, 34 and 36, but they may not all yet actually be installed in device 26. If a user selects a program (e.g., by touching or otherwise activating it's icon on display 38) that is not yet loaded, device 26 can transmit a request to a remote server (not shown) to download it. The program is executed immediately upon downloading. From the user's perspective, any of programs 32, 34, 36 is immediately available for use, regardless of whether it has actually yet been loaded or installed in device 26. The control file is that is downloaded along with the requested program is customized to integrate the combination of programs that will then have been installed. To determine the combination of programs installed on a certain user's device 26 at any given time, the remote server can query the user by prompting the user to identify all programs then installed on his device 26. Alternatively, the remote server can maintain a database of users and the programs they have installed, updating the database each time a user requests an additional program or deletes a program.

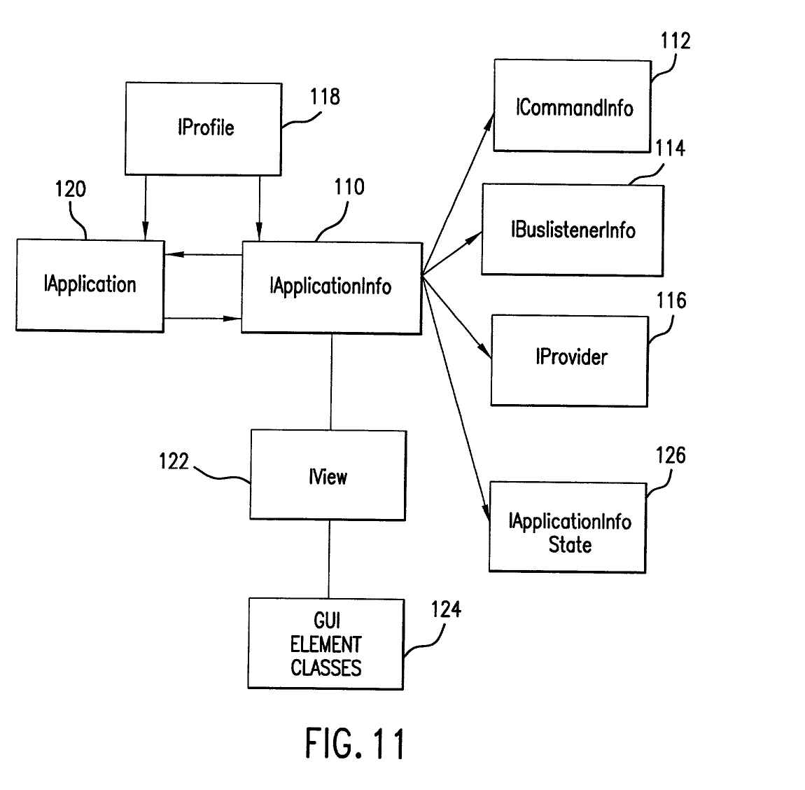

Although the sequence of operation is described in further detail below, when device 26 is initialized by the user by turning it on, logging in, resetting it, or by a similar system startup action, objects are instantiated in accordance with the control file and classes defined by framework 24. Some of these framework classes are shown in the class diagram of FIG. 11. Persons skilled in the art will note that the class names begin with the letter “T” to denote JAVA interface classes rather than implementation classes. IScreenInfo class 110 represents a single screen. Components of class 110 can be read from a configuration file (not shown in FIG. 10) at startup. Class 110 refers to an ICommandInfo class 112, an IBusListenerInfo class 114 and one of three types of an IProvider class 116, a view provider, an I/O provider or a storage provider. Providers are explained below.

The screen represented by IScreenInfo class 110 corresponds to a group of lines of the control file. In other words, an instance of this class is created in response to the group of lines. Each line of the control file has several columns. Referring to FIG. 7A, note that, for example, the first line of the second group of lines from the top (groups being offset from one another by blank lines) includes “App” in the first column, “RootApp.Menu” in the second column, “Main Menu” in the third column and, continuing on FIG. 7B, “com.bonitasoftware.togo.MenuApplication” in the fifth column.

A line with “App” in the first column denotes that the lines that follow correspond to a screen. The second column of such a line is a name for the screen. The third column is a label that is to be displayed on a button or other user interface control of the screen. The fifth column is the name of the application that is to be invoked in response to activation of the user interface control. Some of the lines with “App” in the first column further include an item in the sixth column that relates to the concept of providers, described below.

A line with “Command” in the first column defines the method that is to be invoked in response to a command. ICommandInfo class 112 corresponds to such a line. The second column of such a line is again the screen name, and the third column is again the user interface control label. The fourth column is the address or content 94 of a content holder 86, 88, 90, etc. (See FIG. 8.) In this exemplary control file, the lines beginning with “Command” in the second group of lines have “StartApplicationInfoName” in the fourth column, indicating the address of content holder 90, as described above. As described above, content holder 90 is the special one that responds by invoking a JAVA method 98 associated with a different application than the application that had been executing. The fifth column is the value to be stored in content 94. As described above, framework 24 responds to a change in the value stored in content 94 of content holder 90 by invoking a JAVA method having a name that is the value. Thus, for example, in accordance with the second line of the second group in the exemplary control file of FIGS. 7A-B, activating a button on the main menu (i.e., a screen) labeled “LDAP” is to cause the value “RootApp.LDAPSearch” to be stored in content 94 (i.e., the address “StartApplicationInfoName”), resulting in the invocation of a JAVA method 98 named “RootApp.LDAPSearch.” This method 98 can cause a screen similar to that of FIG. 6A to be displayed, presenting the user with the first screen of the (LDAP) lookup application program 34.

A line in the control file with “BusListener” in the first column defines a bus address (e.g., name 92) and content 94. (See FIG. 8.) IBusListenerInfo class 114 corresponds to such a line. The second column of such a line is the screen name. The third column is the bus address of bus listener 96. The fourth column is a message that is to be sent to the JAVA method 98 when invoked in the manner described above. Thus, a control file can, for example, define a bus listener 96 that listens to an address “emailaddress” and has associated with it (via a “Command” line) a JAVA method “composemail”. Thus, if “COMPOSE” button 80 (FIG. 6B) is activated, such a bus listener 98 responds by invoking “composemail.”

As described above, the “StartApplicationInfoName” bus address is created by framework 24 itself as opposed to application program 32, 34, 36, etc. The creator of the control file can use this address to have framework 24 launch another application in response to a button press. The application program-created type of bus address is represented by bus listener name 92. With regard to the exemplary control file of FIGS. 7A-B, the bus address “previousButton” (FIG. 7A) refers to LDAP application program 34. In creating application program 34, the programmer defines one of bus listeners 96 (in the program code) and develops a method to be called in response to a change in content of the “previousButton” address. The control file illustrated in FIGS. 7A-B is intended only as an example. The functions of which a control file is capable are not limited to those discussed above. Much more that will occur readily to persons of skill in the art can be done in view of the above descriptions of creating user interface controls using the “Command” line, creating bus addresses using the BusListener line, using the bus addresses created by framework 24 or application programs 32, 34, 36, etc., and supplying content 94 (which can be a message, a command or data) at the address.

Other lines in the control file include those having “Name,” “Root” or “Start” in the first column, as in the first three lines of the exemplary control file shown in FIGS. 7A-B. The name is used to identify a control file. It is contemplated that control files be made commercially available along with application programs. For example, a person can maintain installed on his device 26 a control file relating to a set of installed application programs, i.e., an application suite, and later install a different control file (of a different name) and different application suite. A “Root” line identifies an application program that begins executing upon startup. A “Start” line identifies the initial screen upon startup.

IProfile class 118 refers to both an IApplication class 120 and IApplicationInfo class 110, which in turn refer to each other. IProfile Class 118 reads a list (not shown) of installed application programs at startup so that the list can be displayed for the user as a menu from which to select. An object of IApplication Class 120 is instantiated when a user selects from the list one of the applications to run.

IApplicationInfo class 110 is the class that reads in the part of the control file associated with the screen and makes available the appropriate user interface controls associated with IView class 122. IView class 122 has associated with it GUI element classes 124. Classes 124 are platform-specific and thus included in plug-in 30 (FIG. 2), but the others are platform-independent. Classes 124 define the platform characteristics, such as whether the GUI has soft, i.e., graphical, buttons or hard, i.e., actual hardware, buttons, or some other input mechanism, how the input and output mechanisms are used, how many there are, how they are arranged, and any other characteristic that affects how an application program can interface with a user. GUI element classes 124 are platform-specific classes to which an application programmer can interface application programs 32, 34, 36, etc. In addition, an IApplicationInfoState class 126 maintains the state of the application (i.e., installed, uninstalled, instantiated, initialized, started, stopped, etc.)

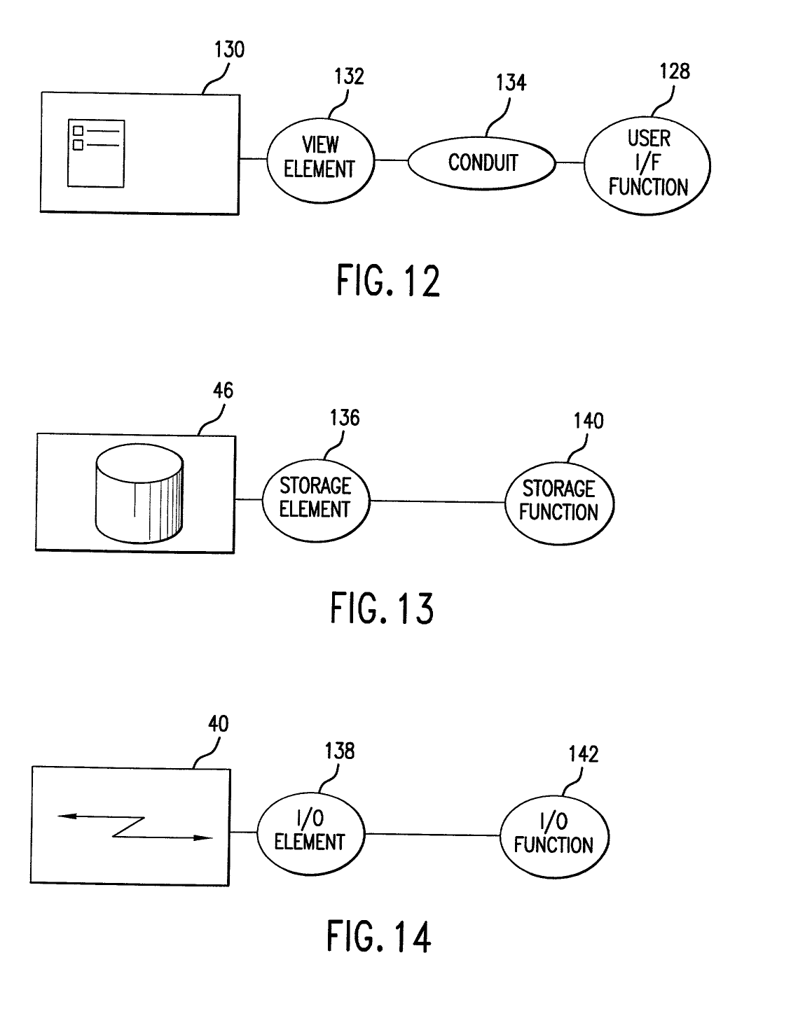

As noted above, an application program 32, 34, 36, etc., performs user interface functions, I/O functions and data storage functions in a platform-independent manner. In other words, the API calls provided by framework 24 (FIG. 2) for such functions are independent of the platform on which framework 24 resides. For example, as illustrated in FIG. 12, a user interface function 128 is independent of the user interface hardware and software 130. User interface hardware and software 130 is part of native operating hardware and software 16 (FIG. 2) and, along with similar hardware and software relating to I/O systems such as network interface 40 and storage subsystem 46 (FIG. 4) characterize the platform of device 26, i.e., distinguish it from other platforms.

The concepts of a “view” and a “provider” are central to achieving the platform-independence for the user interface functions. A “view,” as the term is used in this patent specification, refers to the defining characteristics of the user interface. As described above, these characteristics can include the type and size of screen or other user input and output devices, the type and number of any user interface controls, how the user interface controls or other user interface elements are created and used, and any other characteristics that define how an application program receives input from a user and provides output to a user. Some of these characteristics relate to what is commonly referred to as the “look and feel” of a user interface. A view is defined for each platform on which framework 24 is installed. For example, an API call to a function that creates a user interface input (which would have a name along the lines of “CreateButton” or “CreateCommand”) could have a different meaning depending upon the platform. In the illustrated embodiment of the invention, in which device 26 includes a touch-screen of some specific size and can display buttons of some size and arrangement suitable for the screen and has, for example, a MIDP environment 37, a “CreateButton” or “CreateCommand” type of function can invoke whatever MIDP calls are necessary to cause a button along the lines of those shown in FIG. 3 to be displayed and labeled with appropriate text. In a different platform, however, such as one having only actual or hard buttons (not shown) instead of virtual or soft buttons, the same call to “CreateButton” can cause, for example, a label to be displayed on the screen adjacent one of the buttons. Platforms are contemplated that have radically different user interfaces, such as voice-synthesis and recognition, and “CreateButton” can mean something radically different in a platform having such a “view.” The term “button” is used herein for convenience only, and includes within its meaning any suitable similar type of graphical user input control. In other words, the term includes within its meaning not only actual pushbuttons and virtual or graphical user buttons displayed on a screen, but also any other type of icon or other suitable discrete actual or virtual input. In other words, an application program call to “CreateButton” or similar function creates whatever suitable, analogous kind of user interface input control of which the platform is capable, whether a displayed button, a recognized voice command, or something else. Similarly, as described below, the term “view” as used herein is not limited to graphical or other screen-based user interfaces, despite the visual implication of the ordinary meaning of the term.

A “provider,” as the term is used in this patent specification, is an object of Iprovider class 116 (FIG. 11) that instantiates an object, such as the view component or view element 132 in FIG. 12, that translates between the platform-independent API calls and the platform-dependent JAVA methods or other software instructions. In other words, in OOP terms, view element 132 implements, for the platform at issue, the (platform-independent) methods defined by the (platform-independent) API. Thus, it is actually view element 132 and not the conceptual “view” itself that uniquely corresponds to the platform. A provider is analogous to a JAVA factory class, with which persons skilled in the art are familiar.

View element 132 can, for example, in an embodiment of the invention in which device 26 has a platform defined in part by a MIDP environment 37 (FIG. 2), translate between MIDP API calls and the more generalized, i.e., platform-independent, API calls of framework 24. Plug-in classes 30 (FIG. 2) can include MIDP view classes in such an embodiment. As described below with regard to the analogous platform-independence of I/O and data storage functions and the corresponding providers, plug-in classes 30 can likewise include MIDP I/O classes and MIDP storage classes in such an embodiment. In other words, plug-in classes 30 implement specific interfaces (e.g., user, I/O, storage, etc.) that device 26 may have. Using an appropriate API call, an application program 32, 34, 36, etc. (FIG. 2), can in effect request that a view provider create view element 132 for it.

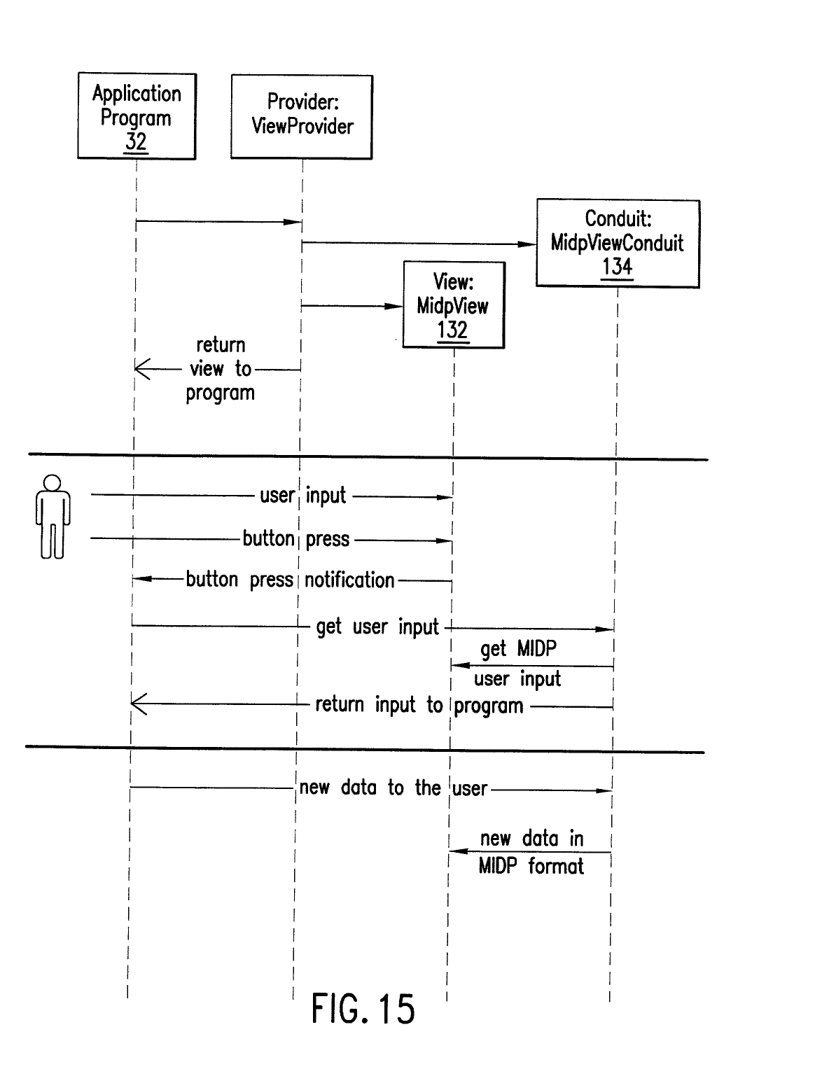

The above-referenced instantiation of view element 132 by a provider occurs dynamically when the application program creates the view. As described above, the view is created in accordance with the control file. At the time the view is created, a conduit object 134 is also instantiated. Each screen of an application program 32, 34, 36, etc. has a corresponding conduit 134. In other words, each conduit 134 is specific to a screen and an application program. A conduit is an example of an adapter, which is a well-known design pattern familiar to persons skilled in the art. When an application program 32, 34, 36, etc. is to communicate with user interface hardware and software 130, it does so via conduit 134. For example, view element 132 receives whatever information the user may have input to the screen (represented in FIG. 12 by user interface hardware and software 130) and in essence translates the information from the platform-dependent format (e.g., MIDP) to a platform-independent format. Conduit 134 gathers this information from view element 132. When a user activates a button or other user interface control (not shown), an application program method (represented in FIG. 12 by user interface function 128) responds by making an API call that causes conduit 134 to gather the information and provide it to the method making the API call. Similar steps occur when the API call relates to outputting information to the screen. Conduit 134 provides the information to view element 132, which translates the information into the platform-dependent format recognized by user interface hardware and software 130. For example, view element 132 can translate or format the information into MIDP format and communicate it to user interface hardware and software by a series of MIDP instructions. FIG. 15 is a sequence diagram illustrating the above-described process.

Similarly, as illustrated in FIG. 13, an application program 32, 34, 36, etc. (FIG. 2) can request that a storage provider create a storage element 136 for it or, as illustrated in FIG. 14, request that an I/O provider create an I/O element 138 for it. In other words, in essentially the same manner described above in which a view provider returns an object that implements a view interface, other types of providers can return objects that implement I/O, data storage or other requested interfaces.

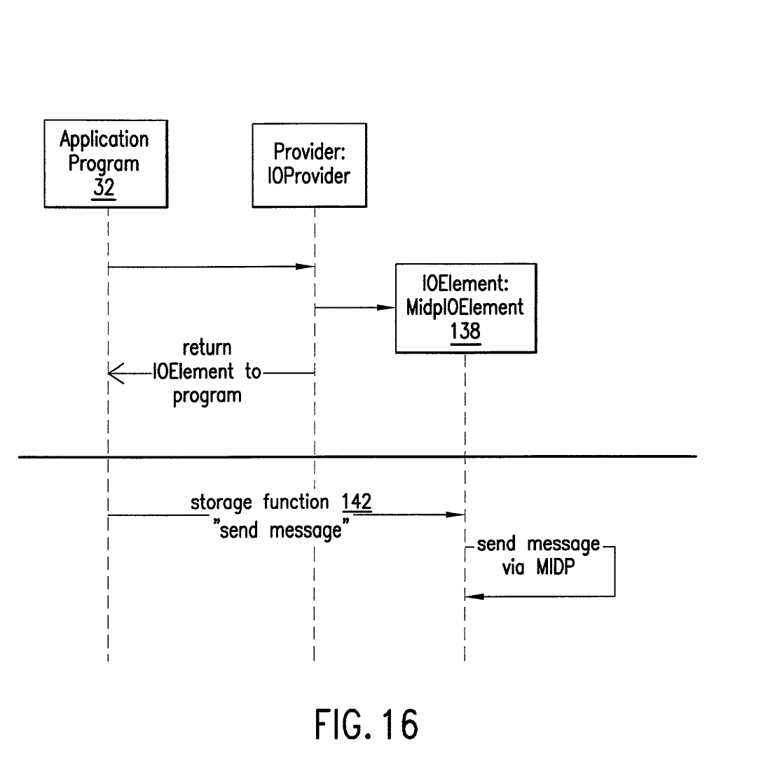

Storage element 136 can, for example, respond to an API call from a storage function 140 by translating the information it receives via that API call into the format and instructions necessary to store the data in data storage subsystem 46. As described above with regard to FIG. 4, data storage subsystem 46 represents the combined hardware and software that effect data storage functions on the platform at issue. As described above, in some platforms data is stored in a file-like manner, in others it is stored in a database-like manner, and in still others data is stored in still other ways. For example, in a MIDP platform, storage is handled differently than in a PALM platform. Each platform may have its own requirements for the format and instructions needed to effect the storage and retrieval of data, and storage element 136 implements that storage interface. FIG. 16 is a sequence diagram illustrating the data storage process.

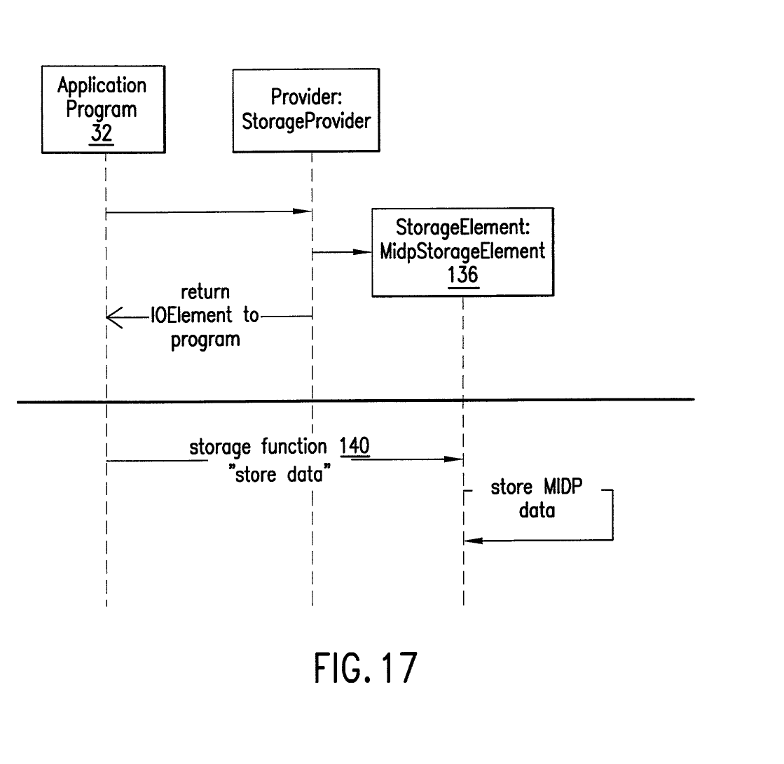

With regard to FIG. 14, I/O element 138 can, for example, respond to an API call from an I/O function 142 by translating the information it receives via that API call into the format and instructions necessary to transmit data via network interface 40. As described above with regard to FIG. 4, network interface 40 represents the combined hardware and software that effect network communication functions on the platform at issue. Network interface 40 on a MIDP platform, for example, may require different instructions and differently formatted data from the network interface on another platform. FIG. 17 is a sequence diagram illustrating the data communication process.

Although framework 24 can be embodied in any suitable programming language, the above-referenced instantiation by a provider is especially efficient in JAVA because JAVA has a dynamic class loading feature, “class.forname(<string>)”, by which it can instantiate an object having a name that is a string passed to the instantiating object. Specifically, in the illustrated embodiment of the invention, the string in the sixth column of a line of the control file (see FIG. 7B) having “App” in the first column is read by an object of the implementation class of IApplicationInfo interface class 110 (FIG. 11) and sent to the view provider (an object of IProvider class 116), which returns view element 132 (FIG. 12). For example, note the string “com.bonitasoftware.atk.basics.View” in FIG. 7B.

It will be apparent to those skilled in the art that various modifications and variations can be made in the present invention without departing from the scope or spirit of the invention. Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A method for controlling screens in an electronic device having a display and a plurality of application programs, each application program having associated with it a plurality of screens, the method comprising the steps of:
detecting user activation of a user interface control represented on the display, the display displaying a representation of a first screen, the representation of the first screen including a representation of the user interface control, the user interface control associated with one and only one of a plurality of commands and included in one of the plurality of screens;
matching a command to the activation of the user interface control associated with the command in response to an indication of the command listed in a control file with indications of the plurality of commands;
one of a plurality of object methods, each associated with one and only one of the plurality of commands, responding to a match between the command listed in the control file and the activation of the user interface control; and
changing the display from displaying a representation of the first screen to displaying a representation of a second screen in response to the object method.

2. The method claimed in claim 1, wherein:
the first screen is associated with a first application program;
the second screen is associated with a second application program; and
the object method invoked by activation of the user interface control of the first screen is included in the second application program.

3. The method claimed in claim 1, wherein:
the first screen is associated with a first application program;
the second screen is associated with the first application program; and
the object method invoked by activation of the user interface control of the first screen is included in the first application program.

4. The method claimed in claim 1, wherein:
the file includes indications of a plurality of user interface control labels, each associated with one of the indications of the plurality of commands; and
the representation of the user interface control on the display includes one of the plurality of user interface control labels.

5. The method claimed in claim 1, wherein the step of detecting user activation of a user interface control comprises:
creating a plurality of bus listeners, at least one bus listener of the plurality of bus listeners corresponding to each user interface control, each bus listener having a corresponding address;
storing a value listed in the control file in an address listed in the control file, the value and address each associated with the command associated with the user interface control; and
a bus listener having the address associated with the command responding to a change in value stored in the address associated with the command by invoking the command.

6. The method claimed in claim 5, wherein:
the first screen is associated with a first application program;
the second screen is associated with a second application program;
the object method invoked by activation of the user interface control of the first screen is included in the second application program; and
the bus listener having the address associated with the command responds to a change in value by invoking a command changing from the first screen to the second screen.

7. A method for providing screen control in an electronic device having a display, the method comprising the steps of:
adding to the device a plurality of application programs, each application program having associated with it a plurality of screens representable on the display, each screen having a user interface control associated with one and only one of a plurality of commands; and
adding to the device a control file with an indication of each command and an associated object method included in one of the application programs, the object method responsive to activation of a user interface control represented on the display by changing the display from displaying a representation of a first screen to displaying a representation of a second screen.

8. The method claimed in claim 7, wherein the object method responsive to activation of a user interface control of the first screen is included in the second application program.

9. The method claimed in claim 7, wherein the object method invoked by activation of a user interface control of the first screen is included in the first application program.

10. A method for controlling screens in an electronic device having a display and a plurality of application programs, each application program having associated with it a plurality of screens, the method comprising the steps of:
adding a second application program to a device having a first application program, the first application program having associated with it a first screen having a first group of one or more user interface controls representable on the display when the first application program is invoked;
updating a control file in the device contemporaneously with the step of adding the second application program, the control file prior to updating including indications of commands associated with object methods in the first application program, the control file after updating including indications of commands associated with object methods in the second application program; and
in response to the step of adding the control file, associating with the first application program a second screen having a second group of one or more user interface controls representable on the display when the first application program is invoked, one or more user interface controls in the second group associated with commands indicated in the control file as associated with object methods in the second application program.

11. The method claimed in claim 10, wherein:
the step of adding a second application program comprises downloading the second application program from a remote source; and
the step of updating a control file comprises downloading the control file from a remote source.

12. A method for executing an application program in an electronic device having a user interface in a platform-independent manner, comprising the steps of:
in an application program, invoking an application program object method to communicate with a user of the device;
a view provider object instantiating a user interface communication object in response to invocation of the object method and in response to an application program interface specified in a collection of platform-dependent plug-in classes, the user interface communication object implementing an interface class in a collection of platform-independent kernel classes, the kernel classes defining platform-independent user interface functions, the plug-in providing platform-dependent implementations of platform-independent user interface functions accessed through the application program interface; and
the user interface communication object translating between a platform-independent user interface function and a platform-dependent user interface function, whereby communication with the user of the device occurs through the platform-dependent user interface function and communication with the application program object method occurs through the platform-independent user interface function.

13. A method for executing an application program in an electronic device having an input/output (I/O) subsystem in a platform-independent manner, comprising the steps of:
in an application program, invoking an application program object method to communicate data between the device and a remote device via a transmission medium;
an I/O provider object instantiating an I/O communication object in response to invocation of the object method and in response to an application program interface specified in a collection of platform-dependent plug-in classes, the I/O communication object implementing an interface class in a collection of platform-independent kernel classes, the kernel classes defining platform-independent user interface functions, the plug-in providing platform-dependent implementations of platform-independent I/O functions accessed through the application program interface; and
the I/O communication object translating between a platform-independent I/O function and a platform-dependent I/O function, whereby communication via the transmission medium occurs through the platform-dependent I/O function and communication with the application program object method occurs through the platform-independent I/O function.

14. A method for executing an application program in an electronic device having a data storage subsystem in a platform-independent manner, comprising the steps of:
in an application program, invoking an application program object method to perform a data transfer operation with the data storage subsystem;
a storage provider object instantiating a storage object in response to invocation of the object method and in response to an application program interface specified in a collection of platform-dependent plug-in classes, the storage object implementing an interface class in a collection of platform-independent kernel classes, the kernel classes defining platform-independent user interface functions, the plug-in providing platform-dependent implementations of platform-independent data storage functions accessed through the application program interface; and
the storage object translating between a platform-independent data storage function and a platform-dependent data storage subsystem function, whereby a transfer of data with the data storage subsystem occurs through the platform-dependent data storage subsystem function and communication with the application program object method occurs through the platform-independent data storage function.

15. An electronic device, comprising:
a display;
a memory in which is storable an object framework, a control file, and a plurality of application programs, each application program having associated with it a plurality of screens, the control file defining interrelationships of screens and user interface controls; and
a processor programmed to effect a method using the object framework comprising the steps of:
detecting user activation of a user interface control represented on the display, the display displaying a representation of a first screen, the representation of the first screen including a representation of the user interface control, the user interface control associated with one and only one of a plurality of commands and included in one of the plurality of screens;
matching a command to the activation of the user interface control associated with the command in response to an indication of the command listed in the control file with indications of the plurality of commands;
one of a plurality of object methods, each associated with one and only one of the plurality of commands, responding to a match between the command listed in the control file and the activation of the user interface control; and
changing the display from displaying a representation of the first screen to displaying a representation of a second screen in response to the object method.

16. The device claimed in claim 15, wherein:
the first screen is associated with a first application program;
the second screen is associated with a second application program; and
the object method invoked by activation of the user interface control of the first screen is included in the second application program.

17. The device claimed in claim 15, wherein:
the first screen is associated with a first application program;
the second screen is associated with the first application program; and
the object method invoked by activation of the user interface control of the first screen is included in the first application program.

18. The device claimed in claim 15, wherein:
the file includes indications of a plurality of user interface control labels, each associated with one of the indications of the plurality of commands; and
the representation of the user interface control on the display includes one of the plurality of user interface control labels.

19. The device claimed in claim 15, wherein the processor effecting the step of detecting user activation of a user interface control comprises:
creating a plurality of bus listeners, at least one bus listener of the plurality of bus listeners corresponding to each user interface control, each bus listener having a corresponding address;
storing a value listed in the control file in an address listed in the control file, the value and address each associated with the command associated with the user interface control; and
a bus listener having the address associated with the command responding to a change in value stored in the address associated with the command by invoking the command.

20. The device claimed in claim 19, wherein:
the first screen is associated with a first application program;
the second screen is associated with a second application program;
the object method invoked by activation of the user interface control of the first screen is included in the second application program; and
the bus listener having the address associated with the command responds to a change in value by invoking a command changing from the first screen to the second screen.

21. The device claimed in claim 15, further comprising:
a personal digital assistant-sized case; and
a wireless data communication interface for communicating data with a remote device.
